(19) United States
(12) Patent Application Publication
(10) Pub. No.: US 2005/0059308 A1
(43) Pub. Date: Mar. 17, 2005

(54) Label for mounting to a tire

(76) Inventor: Edwin D. Parsons, Piedmont, SC (US)

Correspondence Address: Alan A. Csontos;Michelin North America, Inc., P.O. Box 2026, Greenville, SC, 29602, US

(21) Appl. No.: 10/667,174

(22) Filed: Sep. 17, 2003

(51) Int. Cl. B32B 27/12

(52) U.S. Cl. 442/149; 428/304.4

(57) ABSTRACT

A laminate structure or label for mounting on a surface of a tire, for example, a label or RFID tag label, includes a face stock layer of a material permeable to the migratory oils and waxes present in tire rubber. The permeable material allows the oils and waxes to pass through the face stock and prevents their build up between the face stock and the adhesive layer, improving the adherence and durability of adherence of the laminate structure to tire rubber.

### FIELD OF THE INVENTION

The invention relates to adhesive-carrying laminate structures, such as labels, for mounting to tires and other rubber materials.

### BACKGROUND AND SUMMARY

It is a known practice in the tire industry to attach labels to tires, for example, to carry bar codes or other identifying indicia, or as position markers used during match mounting a tire to a wheel.

A well known and long standing problem in the tire industry is that the migratory oils and waxes used in tire rubber shorten the adherence life of labels. A common belief in the industry is that the migratory oils and waxes work to inactivate the adhesive.

While a label can be applied to a green tire and bonded during the vulcanization process, it is still desirable to apply labels to a cured tire, for example, the uniformity position markers are attached to a cured tire because certain uniformity measurements are made only on the cured tire.

The inventor discovered that in labels on tires that had lost adherence the migratory oils and waxes had accumulated under the face stock and had caused the face stock and adhesive layer to separate.

The invention solves this problem by including a face stock or base layer of a material permeable to the migratory components in tire rubber, especially oils and waxes, and a layer of adhesive compatible with tire rubber. The permeable layer allows the migratory components to pass through, and thus, not accumulate between the base layer and adhesive. The inventor found that rubber-based adhesives, rather than being inactivated, generally are permeable to the migratory components in rubber, and allow the components to pass through the adhesive layer.

The permeable base layer can be a porous material, a foamed rubber, a cloth, or any material capable of being formed as a face stock for a label. Preferably, the base layer is a woven or non-woven cloth. More preferably, the base layer is a cloth made of a fiber that does not itself absorb, or is coated so it does not absorb, the migratory oils and waxes or other components to prevent deterioration of the quality of the face stock.

According to another embodiment of the invention, the label may be a laminate structure for affixing a RFID (radio frequency identification) tag to a tire, including a base layer, an adhesive layer, and a RFID tag disposed in contact with the adhesive layer.

### BRIEF DESCRIPTION OF THE DRAWINGS

The invention will be better comprehended through reference to the following Detailed Description in conjunction with the appended drawings, in which:

FIG. 1 is a schematic representation of an embodiment of a laminate structure for affixing to a tire in accordance with the invention;

FIG. 2 is a schematic representation of an alternative embodiment of a laminate structure including an RFID tag; and,

FIG. 3 is a schematic representation of a laminate structure similar to that of FIG. 2 with an alternative placement of the RFID tag.

### DETAILED DESCRIPTION

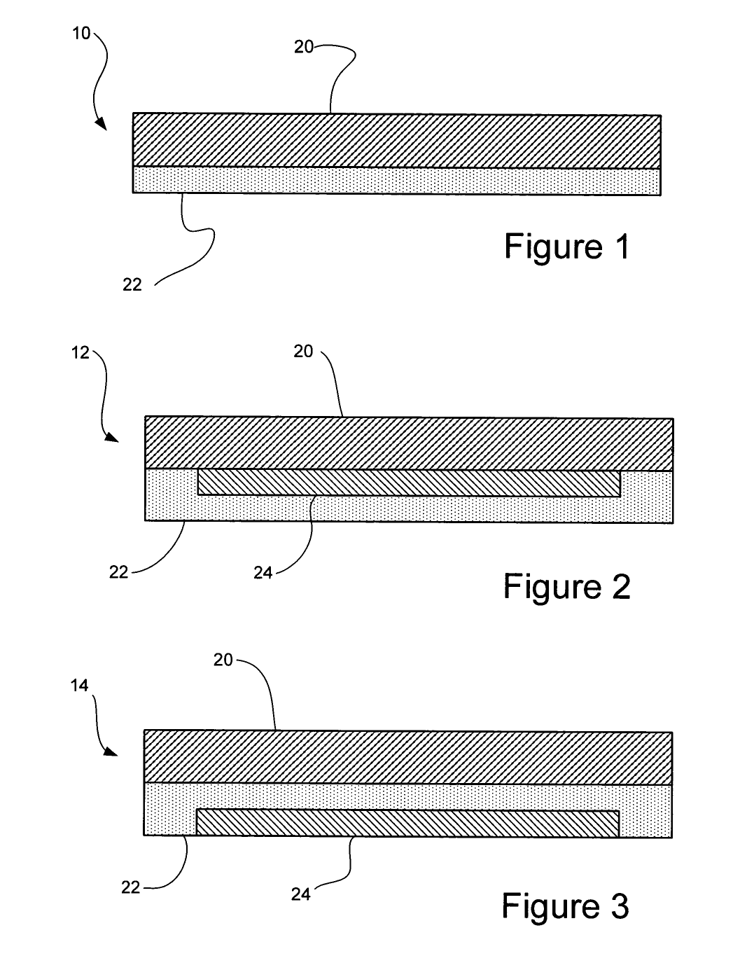

A label 10 in accordance with a first embodiment of the invention is illustrated in FIG. 1. It should be noted that the figures are not drawn to scale and no reliance or conclusion on the relative sizes or dimensions of the illustrated component parts should be made. The label 10 includes a base layer 20, which serves as the face stock in a label, and an adhesive layer 22. The base layer 20 is made to be permeable to the migratory components, including the waxes and oils that are present in tire and other rubber. The migratory components will be known to those of skill in the tire and rubber arts, and include extender oils, preservative waxes and oils, additives used to aid processing, and the like.

The base layer 20 is permeable to the migratory components in rubber and may be made so in any convenient manner. According to one embodiment, the base layer 20 is a cloth, either woven or nonwoven, in which the space between fibers is left open, for example, not filled or covered by a coating layer on the cloth. To prevent deterioration, the fibers may be selected to be non-absorbent or non-reactive to the migratory components, or may be coated to be non-absorbent or non-reactive. A cloth having a permeable coating may also be used, which may be made permeable by applying and then allowing the coating to dry in contact with the cloth, or by stretching the coated cloth.

The base layer 20 may alternatively be a perforated sheet. A perforated sheet may be formed by mechanically perforating (punching) a sheet material or otherwise causing perforations to form in a sheet material or coated cloth. For example, a perforated sheet may be made a chemical process by which a material that is included in the formation of the sheet is leached out to form the perforations.

Another alternative embodiment is a porous material, for example, a foamed material such as a foam rubber or foamed plastic, such as polyurethane. A further alternative embodiment is a rubber material that sufficiently similar to the rubber product to be permeable to the migratory components in the rubber product.

The base layer 20 should be capable of carrying printing, dye, or paint so that indicia may be formed on and carried by the label. In addition, the base layer 20 should be sufficiently flexible to conform to the tire or rubber article surface and survive bending that the tire or rubber article may experience during handling, mounting on a wheel, inflating and seating, and similar conditions.

The adhesive layer 22 is preferably formed of a rubber based adhesive, such as those known in the art, for compatibility with the tire rubber and migratory components. The adhesive layer 22 may be applied in a convenient thickness for the shape and roughness of the surface to which the label will be applied.

FIG. 2 illustrates an alternative embodiment of the invention, in which a radio frequency identification (RFID) tag is incorporated in a label 12. The label 12 includes a base layer 20 and adhesive layer 22 as described above. A RFID tag 24 is in contact with the adhesive layer 22, and as illustrated in this embodiment, interposed between the base layer 20 and the adhesive layer 22. As is known in the RFID art, a RFID tag 24 will typically include a chip and an antenna. The antenna may be a formed wire connected to the chip or may be printed or carried, along with the chip, on a substrate. The RFID tag may be coated to insulate it from the tire surface and/or to promote adhesion with the adhesive layer 22. Co-pending applications PCT/US02/18411 and PCT/US02/38411, which are owned in common with the present application, disclose methods and materials for coating a RFID antenna that is to be embedded in or attached to a rubber article, such as a tire, and are incorporated herein by reference for all they disclose.

For embodiments including a RFID tag, it may not be necessary that the base layer 20 be capable of carrying printed matter, as the tag serves to carry the information.

FIG. 3 shows an alternative to the embodiment of FIG. 2, in which the label 14 includes a RFID tag 24 positioned in contact with the adhesive layer 22 on a mounting surface of the label, that is, a surface that will be in contact with the tire or rubber article.

While the invention has been described in terms of exemplary and preferred components and embodiments, those skilled in the art will understand that substitutions and additions may be made for what is described here without departing from the scope of the invention as defined by the following claims.

1. A label for a tire, comprising:
a base layer having a face side and a mounting side comprising a material permeable to migratory materials in tire rubber, and,
a layer of adhesive compatible with tire rubber carried on the mounting side of the base layer,
wherein, the label is mountable to a tire.

2. The label according to claim 1, wherein the adhesive is a rubber based adhesive.

3. The label according to claim 1, wherein the base layer material is a porous material.

4. The label according to claim 1, wherein the base layer material is a cloth.

5. The label according to claim 4, wherein the cloth is comprised of plastic coated fibers.

6. The label according to claim 4, wherein the cloth is comprised of plastic fibers.

7. The label according to claim 1, wherein the base layer material comprises a foamed material.

8. The label according to claim 7, wherein the base layer is a foam rubber.

9. The label according to claim 1, wherein the base layer material is a rubber.

10. The label according to claim 1, further comprising indicia formed on the face side of the base layer.

11. The laminate structure according to claim 1, further comprising a radio frequency identification tag incorporated at the adhesive layer.

12. A label for mounting to a tire, comprising:
a base layer having a face side and a mounting side comprising a material permeable to migratory components in tire rubber;
a layer of adhesive carried on the mounting side of the base layer; and
a RFID tag in contact with the adhesive layer,
wherein, the laminate structure is mountable to a surface of a tire to secure the RFID tag to the tire.

13. The label as claimed in claim 12, further comprising an insulating coating formed on the RFID tag.

14. The label as claimed in claim 12, wherein the adhesive is a rubber based adhesive.

15. The laminate structure according to claim 12, wherein the base layer material is a porous material.

16. The laminate structure according to claim 12, wherein the base layer material is a cloth.

17. The laminate structure according to claim 12, wherein the base layer material comprises a foam material.

18. The laminate structure according to claim 12, wherein the base layer material is a rubber.

19. The laminate structure according to claim 12, further comprising indicia formed on the face side of the base layer.
